(19) United States
(12) Patent Application Publication
(10) Pub. No.: US 2021/0388638 A1
(43) Pub. Date: Dec. 16, 2021

(54) ELECTRO-MECHANICAL LOCK CORE WITH A CAM MEMBER TAILPIECE

(71) Applicant: dormakaba USA Inc., Indianapolis, IN (US)

(72) Inventors: John Andrew Snodgrass, Indianapolis, IN (US); Brendon Allen, Indianapolis, IN (US); Street Anthony Barnett, III, Indianapolis, IN (US)

(21) Appl. No.: 17/419,665

(22) PCT Filed: Mar. 31, 2020
(86) PCT No.: PCT/US2020/025961

§ 371 Date: Jun. 29, 2021

Related U.S. Application Data
(60) Provisional application No. 62/829,768, filed on Apr. 5, 2019.

(51) Int. Cl. E05B 47/00; E05B 65/00

(52) U.S. Cl. CPC E05B 47/0012; E05B 2047/0058; E05B 2047/0024; E05B 65/0021

(57) ABSTRACT

A removable lock core for use with a lock device having a locked state and an unlocked state is disclosed. The removeable lock core may include a cam member tailpiece which is moveable between a first position relative to a lock core body which corresponds to the lock device being in the locked state and a second position relative to a lock core body which permits removal of the removeable lock core from the lock device which corresponds to the lock device being in the unlocked state. The removeable lock core may include an electro-mechanical drive assembly which in a disengaged state is decoupled from the cam member tailpiece and in an engaged state is coupled to the cam member tailpiece. A cam lock having a locked state and an unlocked state for use with a catch is disclosed.

### CROSS-REFERENCE TO RELATED APPLICATIONS

This application is a 371 national stage application of PCT Patent Application No. PCT/US20/25961, filed Mar. 31, 2020, titled ELECTRO-MECHANICAL LOCK CORE WITH A CAM MEMBER TAILPIECE which claims the benefit of US Provisional Application No. 62/829,768, filed Apr. 5, 2019,titled ELECTRO-MECHANICAL LOCK CORE WITH A CAM MEMBER TAIL PIECE, the entire disclosures of which are expressly incorporated by reference herein.

This application is related to U.S. Provisional Application No. 62/833,314, filed Apr. 5, 2019, titled ELECTRO-MECHANICAL LOCK CORE, docket BAS-2018503-03-US; PCT Application No. PCT/US19/27220; U.S. Design application Ser. No. 29/686,585, filed Apr. 5, 2019, titled KNOB, docket BAS-2018515-01-US, U.S. Provisional Application No. 62/829,778, filed Apr. 5, 2019, docket BAS-2019502-01US, titled ELECTRO-MECHANICAL STORAGE DOOR LOCK, and U.S. Provisional Application No. 62/872,121, titled ELECTRONIC LOCK, the entire disclosures of which are expressly incorporated by reference herein.

### FIELD

The present disclosure relates to lock cores and in particular to lock cores having an electro-mechanical locking system.

### BACKGROUND

In one application, storage lockers with rollup doors are often secured using small mechanical lock cores which are operated by a key. When the key is rotated, it brings a cam into alignment to permit removal of the entire core from the lock. Thus, it is the body of the core itself which blocks movement of the bolt. This design, though simple and cost-effective, suffers from the limitations inherent to a purely mechanical system.

In another application, improvements in traditional cam locks, such as for cabinets, drawers, and other applications, wherein a cam tailpiece moves to lock and unlock are needed.

### SUMMARY

In embodiments, a removeable electro-mechanical lock core for use with a lock device having a locked state and an unlocked state is provided.

In an exemplary embodiment of the present disclosure, a method of unlocking a lock is provided. The method comprising the steps of blocking a movement of a lock member from a locked state to an unlocked state with a removeable lock core having a lock core body which is positioned in an aperture of the lock member when the lock member is in the locked state and is removed from the aperture of the lock member to transition the lock member to the unlocked state; holding a cam member tailpiece of the removeable lock core in a first cam member tailpiece position which blocks removal of the lock core body from the aperture of the lock member; providing an operator actuatable input supported by the removeable lock core, an electro-mechanical drive assembly having an engaged state wherein the operator actuatable input is operatively coupled with the cam member tailpiece so that a rotation of the operator actuatable input causes a movement of the cam member tailpiece from the first cam member tailpiece position to a second cam member tailpiece position, the second cam member tailpiece position permitting removal of the lock core body from the aperture of the lock member and a disengaged state wherein the operator actuatable input is operatively uncoupled from the cam member tailpiece; communicating credential information between an electronic controller of the removeable lock core and a portable user device; granting access to unlock the lock based on the credential information; and transitioning the electro-mechanical drive assembly from the disengaged state to the engaged state.

In an example thereof, the step of transitioning the electro-mechanical drive assembly from the disengaged state to the engaged state is performed automatically without a manual manipulation of the operator actuatable input.

In another example thereof, the method further comprising the step of subsequent to a rotation of the operator actuatable input to move the cam member tailpiece from the first cam member tailpiece position to the second cam member tailpiece position, holding the cam member tailpiece of the removeable lock core in the second cam member tailpiece position.

In another embodiment of the present disclosure, a removeable lock core is provided. The removeable lock core comprising a lock core body having a longitudinal axis and an exterior lock core body envelope surrounding the longitudinal axis; a drive member supported by the lock core body and moveable relative to the lock core body; a cam member tailpiece having an outer cam member tailpiece envelope, the cam member tailpiece extending from a first end of the lock core body and operatively coupled to the drive member, the cam member tailpiece being positionable in at least a first cam member tailpiece position relative to the lock core body wherein at least a portion of the outer cam member tailpiece envelope extends outside of the exterior lock core body envelope and a second cam member tailpiece position relative to the lock core body wherein the outer cam member tailpiece envelope is within the exterior lock core body envelope; an electro-mechanical drive assembly including a clutch moveable between a first clutch position wherein the clutch is operatively disengaged from the drive member and a second clutch position wherein the clutch is operatively engaged to the drive member; and an indexer which assists in holding the cam member tailpiece in a first cam member tailpiece position when the clutch is in the first clutch position.

In an example thereof, the indexer further assists in holding the cam member tailpiece in the second cam member tailpiece position.

In another example thereof, the indexer is positioned within an interior of the lock core body. In a variation thereof, the indexer includes a first collar secured to the drive member to rotate with the drive member and a second collar which does not rotate with the drive member. In a further variation thereof, the drive member passes through each of the first collar and the second collar. In still a further variation thereof, each of the first collar and the second collar include a series of interactive protrusions and recesses, a first protrusion of the first collar being received in a first recess of the second collar when the cam member tailpiece is in the first cam member tailpiece position and the first protrusion of the first collar being received in a second recess of the second collar when the cam member tailpiece is in the second cam member tailpiece position. In yet another variation thereof, the second collar is translatable along the longitudinal axis relative to the first collar and the lock core further comprising a biasing member positioned to bias the second collar into contact with the first collar when the clutch is in the first position.

In still a further example, the electro-mechanical drive assembly further comprises an operator actuatable input moveably coupled to the lock core body; an electric motor operatively coupled to the clutch to position the clutch in the first clutch position; and a power source operatively coupled to the electric motor. In a variation thereof, the electric motor is operatively coupled to the clutch to position the clutch in the second clutch position wherein the clutch is operatively engaged to the drive member. In another variation thereof, the operator actuatable input is freely rotatable about the longitudinal axis relative to the drive member when the clutch is in the first position and is rotatable about the longitudinal axis only through a defined angular range when the clutch is in the second position, a first end of the defined angular range corresponding to the cam member tailpiece being in the first cam member tailpiece position relative to the lock core body and a second end of the defined angular range corresponding to the cam member tailpiece being in the second cam member tailpiece position relative to the lock core body.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 illustrates a front perspective view of a removeable electro-mechanical lock core with a cam member tailpiece;

FIG. 2 illustrates a rear perspective view of the removeable electro-mechanical lock core of FIG. 1;

FIG. 3 illustrates an exploded view of a lock core assembly of the removeable electro-mechanical lock core of FIG. 1 and an operator actuatable assembly of the removeable electro-mechanical lock core of FIG. 1;

FIG. 4 illustrates a sectional view of the removeable electro-mechanical lock core of FIG. 1 along lines 4-4 in FIG. 1, the removeable electro-mechanical lock core being inserted into a door and through an opening in a bolt lock member with the cam member tailpiece of the removeable electro-mechanical lock core in a locked position;

FIG. 4A illustrates a partial sectional view of the assembly in FIG. 4 with the cam member tailpiece of the removeable electro-mechanical lock core in an unlocked position;

FIG. 5 illustrates a sectional view of the removeable electro-mechanical lock core of FIG. 1 along lines 5-5 in FIG. 1;

FIG. 6 illustrates a lock core body of the lock core assembly in section to illustrate a driver and locator of the lock core assembly;

FIG. 7 illustrates a sectional view of the removeable electro-mechanical lock core of FIG. 1 along lines 7-7 in FIG. 1 with the outer lock core body removed for clarity;

FIG. 8 illustrates a front perspective view of another removeable electro-mechanical lock core with a cam member tailpiece;

FIG. 9 illustrates the removeable electro-mechanical lock core of FIG. 8 with the cam member tailpiece in a locked position relative to a retainer of a barrier; and

FIG. 10 illustrates the removeable electro-mechanical lock core of FIG. 8 with the operator actuatable assembly uncoupled from the lock core assembly.

Corresponding reference characters indicate corresponding parts throughout the several views. The exemplification set out herein illustrates an exemplary embodiment of the invention and such exemplification is not to be construed as limiting the scope of the invention in any manner.

### DETAILED DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, and fourth, is used in reference to various components or features. Such use is not intended to denote an ordering of the components or features. Rather, numeric terminology is used to assist the reader in identifying the component or features being referenced and should not be narrowly interpreted as providing a specific order of components or features.

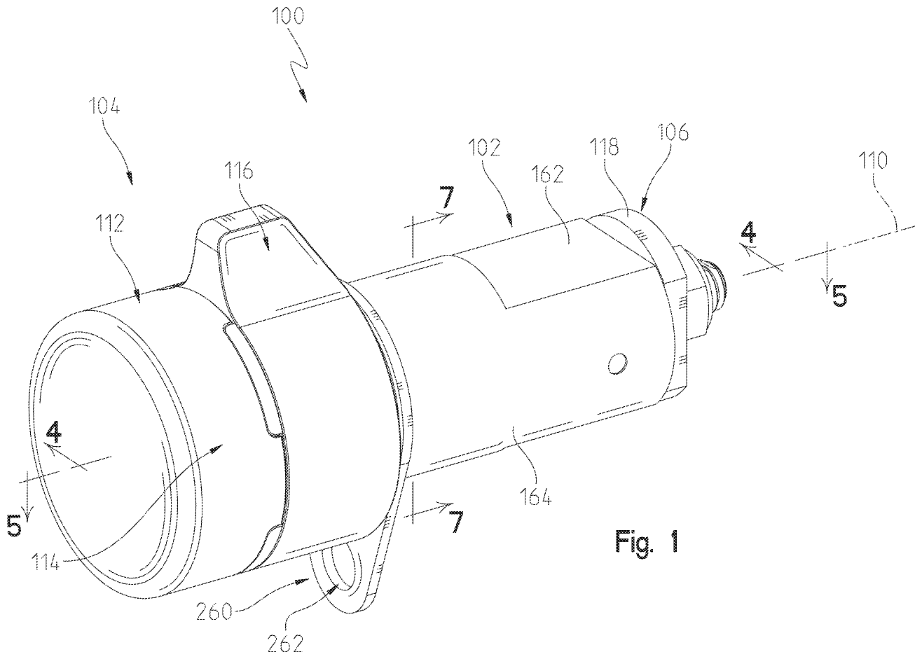

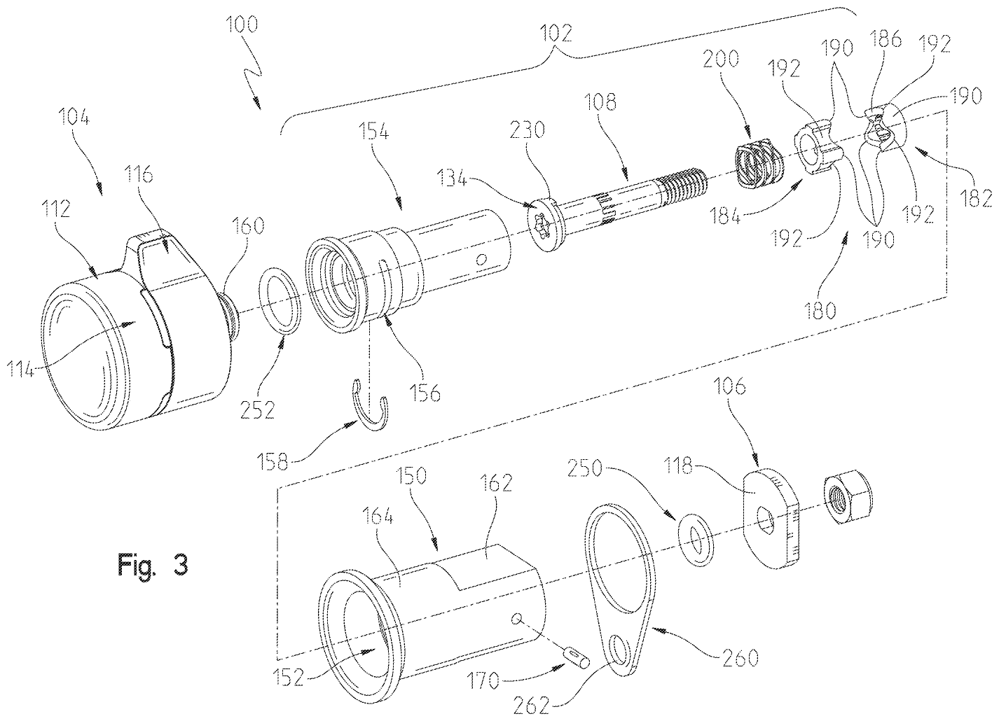

Referring to FIGS. 1-7, an electro-mechanical lock core 100 includes a core assembly 102 and an operator actuation assembly 104. As explained herein in more detail, in certain configurations operator actuation assembly 104 may be actuated to rotate a cam member tailpiece 106 through the rotation of a drive member 108 (see FIG. 3) of core assembly 102 about a longitudinal axis 110.

Operator actuation assembly 104 includes an operator actuation input 112 which includes a generally cylindrical knob 114 and a thumb tab 116. Further, although operator actuation assembly 104 is illustrated as including a generally cylindrical knob and thumb tab, other user actuatable input devices may be used including handles, levers, and other suitable devices for interaction with an operator.

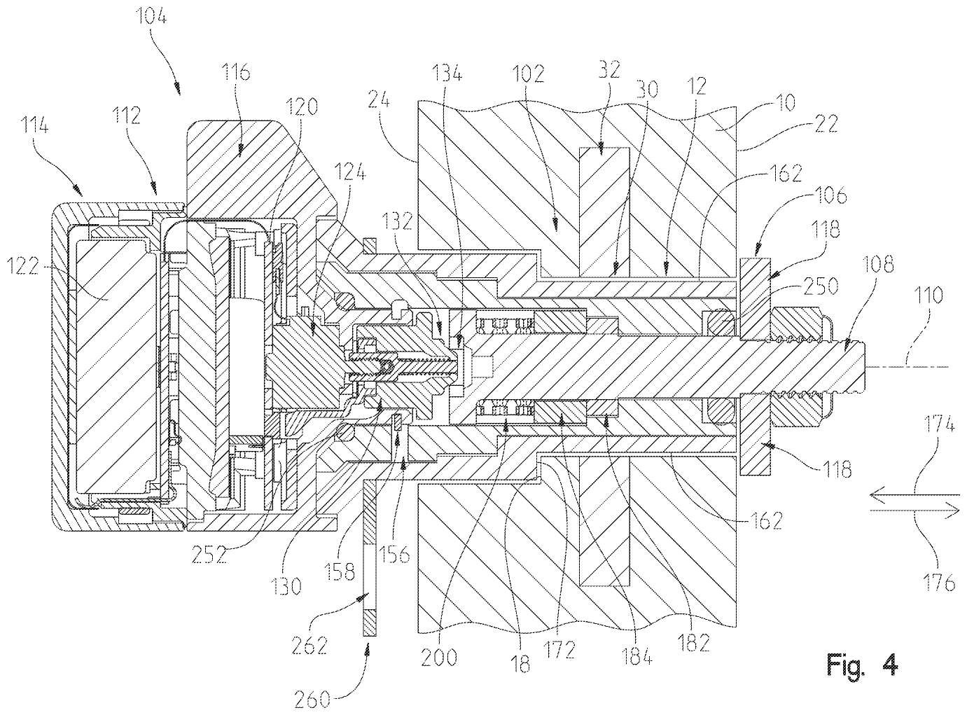

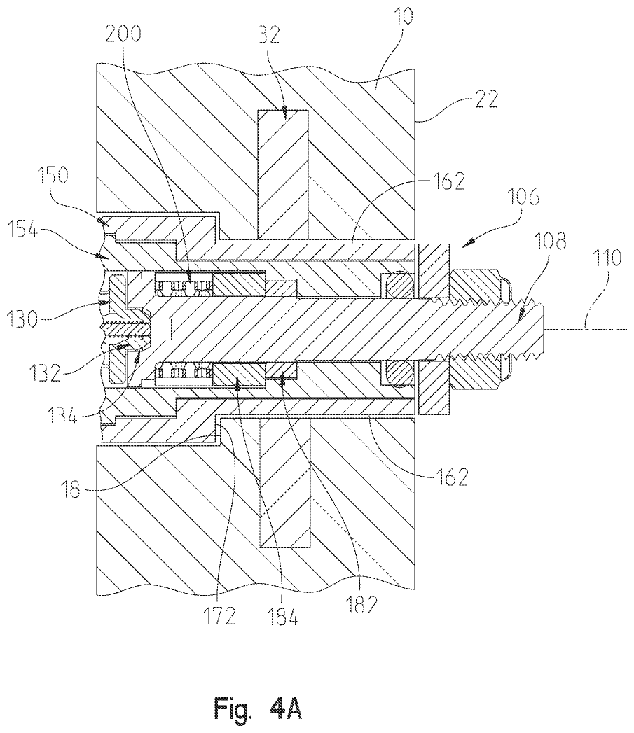

Referring to FIG. 4, operator actuation assembly 104 further includes an electronic controller 120 including one or more processing circuits, such as microprocessors, and memory which stores processing instructions and/or data. Electronic controller 120 cooperates with a portable user device, such as a mobile phone or fob, to determine if a user has access rights to actuate cam member tailpiece 106 of electro-mechanical lock core 100. In embodiments, the portable user device provides credential information to electronic controller 120 which, in turn, makes a determination whether the operator has access rights to actuate cam member tailpiece 106 of electro-mechanical lock core 100 or not. In embodiments, electronic controller 120 provides credential information to the portable user device which, in turn, makes a determination whether the operator has access rights to actuate cam member tailpiece 106 of electro-mechanical lock core 100 or not. In embodiments, one or both of the portable user device and electronic controller 120 provides credential information to a remote computing device which, in turn, makes a determination whether the operator has access rights to actuate cam member tailpiece 106 of electro-mechanical lock core 100 or not.

Operator actuation assembly 104 further includes a power source 122, illustratively a battery, which powers electronic controller 120 and an electric motor 124. Electric motor 124 drives a clutch 130 to position the clutch 130 relative to drive member 108. An engagement interface 132 of clutch 130 cooperates with an engagement interface 134 of drive member 108 to couple operator actuation assembly 104 to cam member tailpiece 106. In embodiments, electric motor 124 positions clutch 130 in a first position wherein engagement interface 132 of clutch 130 is disengaged from engagement interface 134 of drive member 108 and a second position wherein engagement interface 132 of clutch 130 is engaged with engagement interface 134 of drive member 108. In alternative embodiments, operator actuation assembly 104 is translatable along longitudinal axis 110 towards drive member 108 and electric motor 124 positions clutch 130 in a first position wherein engagement interface 132 of clutch 130 is disengaged from engagement interface 134 of drive member 108 regardless of a longitudinal position of operator actuation assembly 104 along longitudinal axis 110 and a second position wherein engagement interface 132 of clutch 130 is engaged with engagement interface 134 of drive member 108 either by electric motor 124 or when operator actuation assembly 104 is translated along longitudinal axis 110 towards drive member 108.

In the illustrated embodiment, clutch 130 is part of operator actuation assembly 104. In alternative embodiments, clutch 130 is part of core assembly 102 and is operatively coupled to electric motor 124 through one or more couplers. Additional details regarding the structure and operation of operator actuation assembly 104 are provided in U.S. Provisional Application No. 62/829,974, filed Apr. 5, 2019, titled ELECTRO-MECHANICAL LOCK CORE, docket BAS-2018503-02-US, the entire disclosure of which is expressly incorporated by reference herein.

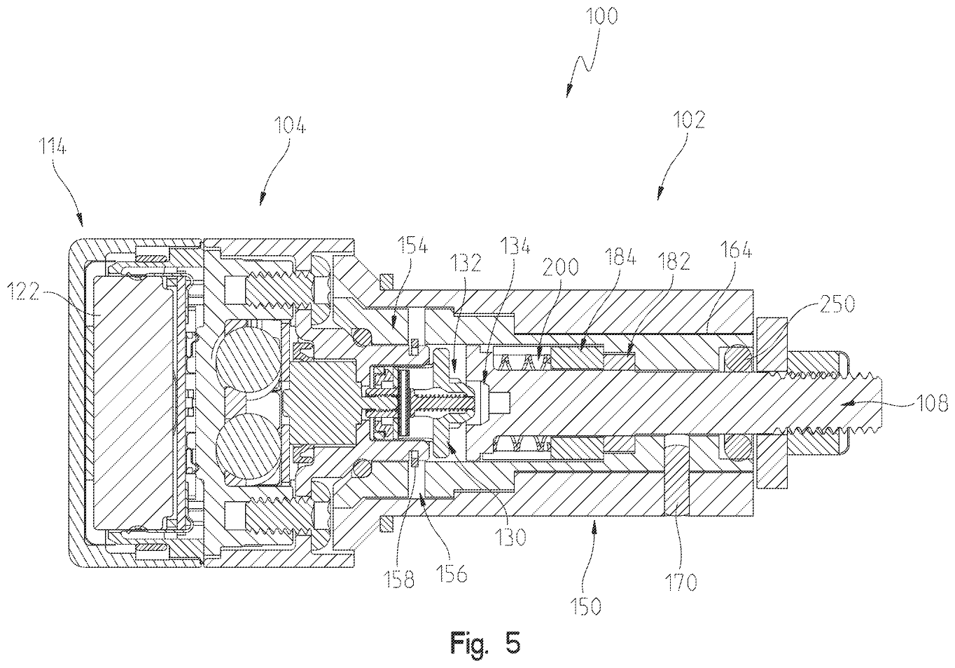

Returning to FIG. 3, core assembly 102 includes drive member 108, a lock core body 150 having an interior 152, and a sleeve 154 positioned within interior 152 of lock core body 150. Sleeve 154 includes an aperture 156 which receives a retainer 158, illustratively a C-clip, which is also received in a recess 160 of operator actuation assembly 104 to couple operator actuation assembly 104 to core assembly 102. Sleeve 154 is coupled to lock core body 150 with a retainer 170, illustratively a pin (see FIG. 5). Lock core body 150 blocks access to retainer 158 when sleeve 154 is assembled to lock core body 150. Further, retainer 170 prevents the rotation of sleeve 154 relative to lock core body 150 while retainer 158 permits operator actuation assembly 104 to freely spin relative to core assembly 102 while clutch 130 is disengaged from drive member 108. In embodiments, lock core body 150 and sleeve 154 are combined into a single component.

Core assembly 102 further includes an indexer 180. Indexer 180 ensures that as drive member 108 is rotated about longitudinal axis 110 that cam member tailpiece 106 is positioned in one of plurality of predetermined orientations relative to lock core body 150. Indexer 180 includes a first collar 182 and a second collar 184 moveable relative to the first collar 182.

First collar 182 is coupled to drive member 108 to rotate with drive member 108. In the illustrated embodiment, first collar 182 is coupled to drive member 108 through a splined connection. Other exemplary methods of coupling first collar 182 to drive member 108 may be implemented including a fastener, an adhesive, welding, or other suitable coupling means. Second collar 184 is moveably coupled to sleeve 154. In the illustrated embodiment, second collar 184 is coupled to sleeve 154 through a splined connection. Other exemplary methods of coupling second collar 184 to sleeve 154 may be implemented.

Second collar 184 is moveable along longitudinal axis 110 relative to sleeve 154 but is prevented from rotation about longitudinal axis 110 relative to sleeve 154. First collar 182 includes a contoured surface 186 and second collar 184 includes a contoured surface 188. Each of contoured surface 186 and contoured surface 188 includes a plurality of detents, protrusions 190 and recesses 192, which mate with corresponding detents, protrusions 190 and recesses 192, of the other of first collar 182 and second collar 184.

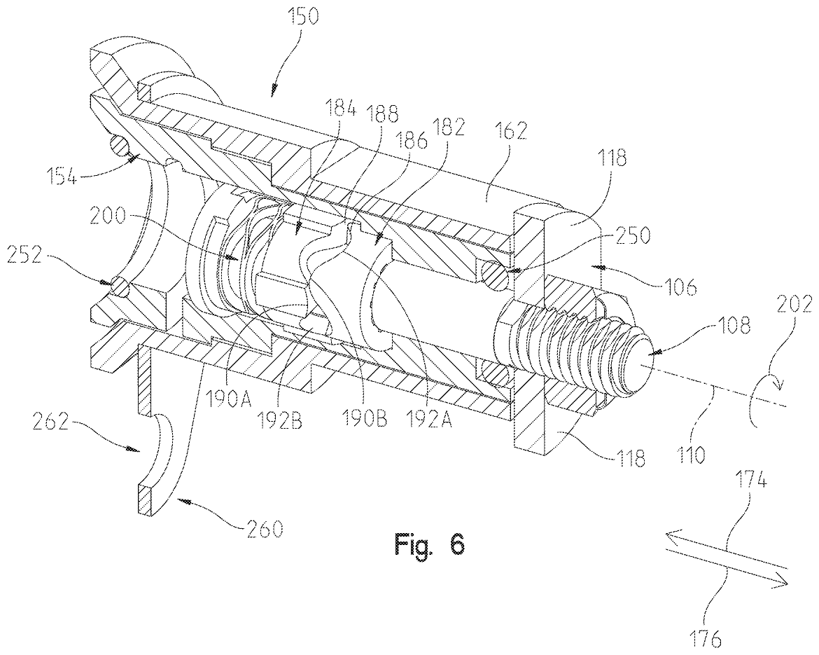

A biasing member 200 biases second collar 184 into contact with first collar 182. Illustratively, biasing member 200 is a wave spring or other suitable compression type spring. Referring to FIG. 6, second collar 184 is rotationally misaligned with first collar 182. Due to the biasing force of biasing member 200 on second collar 184, as drive member 108 is rotated in direction 202 about longitudinal axis 110, protrusion 190A of second collar 184 is received in recess 192A of first collar 182, protrusion 190B of first collar 182 is received in recess 192B of second collar 184, and so on around first collar 182 and second collar 184.

When the protrusions 190 and recesses 192 of first collar 182 and second collar 184 are aligned, biasing member 200 provides a resistance to a further rotation of drive member 108 about 110. This resistance provides a tactile feedback to the operator rotating operator actuation assembly 104 and prevents unintended rotation of drive member 108 about longitudinal axis 110 due to vibrations or other environmental characteristics in the absence of an actuation by an operator.

In the illustrated embodiment, each of first collar 182 and second collar 184 includes four protrusions 190 and corresponding recesses 192. This results in indexer 180 having potentially four defined rotational home positions of drive member 108 relative to sleeve 154 about longitudinal axis 110. Each home position is separated from the adjacent position by 90°. Drive member 108 may be rotated from one home position to an adjacent home position through a rotation of operator actuation assembly 104 when clutch 130 is engaged with drive member 108, but indexer 180 will provide a resistance to movement from the current home position of indexer 180 for approximately 50% of the rotation towards the next home position, assist in moving towards the next home position for approximately the next 50% of the rotation towards the next home position, and provide a tactile feedback when the next home position is reached. As first collar 182 is rotated due to a rotation of drive member 108, second collar 184 is translated rearward in direction 174 (see FIG. 6) along longitudinal axis 110 against the bias of biasing member 200 which increases the resistance on further rotation of first collar 182 until first collar 182 has rotated at least halfway towards the next home position and second collar 184 begins to translate forward in direction 176 along longitudinal axis 110. Although four home positions, 90° apart, are possible with first collar 182 and second collar 184, the number of home positions may be adjusted by changing the number of protrusions 190 and recesses 192 on each of first collar 182 and second collar 184.

Referring to FIG. 4, electro-mechanical lock core 100 is inserted into a passageway 12 of a door or frame 10. Electro-mechanical lock core 100 is inserted into passageway 12 until a shoulder 172 of electro-mechanical lock core 100 contacts a shoulder 18 of door or frame 10. At this depth, cam member tailpiece 106 extends beyond a rear side 22 of door or frame 10 while operator actuation assembly 104 remains forward of a front side 24 of door or frame 10. Electro-mechanical lock core 100 also passes through an opening 30 in a bolt 32 which is moveable in a direction orthogonal to the sectional view (in-out of the page) to lock or unlock the door or frame 10 to a surrounding wall or frame (not shown). When electro-mechanical lock core 100 is positioned in opening 30 of bolt 32, bolt 32 is not moveable to unlock the door or frame 10 relative to the surrounding wall or frame. When electro-mechanical lock core 100 is removed from opening 30 of bolt 32, bolt 32 is moveable to unlock the door or frame 10 relative to the surrounding wall or frame.

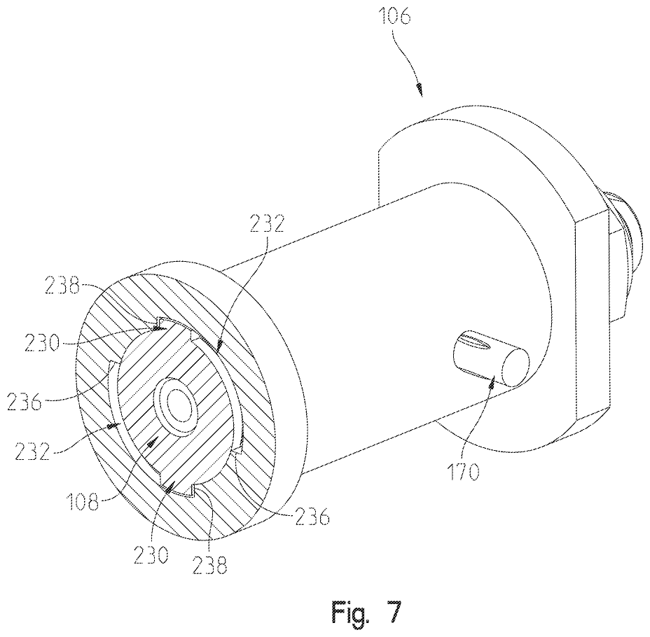

Although indexer 180 has four potential home positions, electro-mechanical lock core 100 limits a rotation of drive member 108 about longitudinal axis 110 to two home positions 90° apart. Referring to FIG. 7, drive member 108 includes stops 230 which travel in guides 232 of sleeve 154 as drive member 108 is rotated about longitudinal axis 110 through a defined angular range of movement. Tabs 230 contact stop surfaces 236 at a first rotational limit of drive member 108 and contact stop surfaces 238 at a second rotational limit of drive member 108. In other embodiments, a pin may be placed in an annular groove of sleeve 154 to limit a rotation of drive member 108 about longitudinal axis 110.

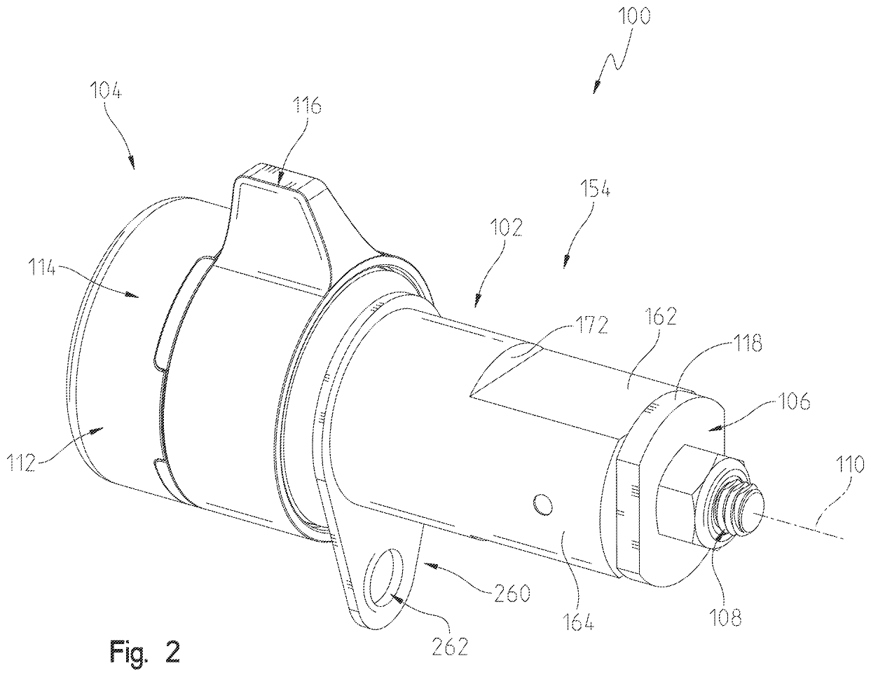

A first home position is a locked position wherein cam member tailpiece 106 is rotated about longitudinal axis 110 so that elongated portions 118 of cam member tailpiece 106 extend over a portion of rear side 22 of door or frame 10 (see FIG. 4) and beyond surfaces 162 of sleeve 154 (see FIGS. 2 and 4). In this position a portion of an outer cam member tailpiece envelope of cam member tailpiece 106 extends outside of the exterior lock core body envelope of lock core body 150, illustratively elongated portions 118 of cam member tailpiece 106 extend beyond the envelope about longitudinal axis 110 made by surfaces 162 and 164 of lock core body 150. When first collar 182 and second collar 184 are in the first home position, stops 230 of drive member 108 contact stop surfaces 238 of guides 232 in sleeve 154. A second home position is an unlocked position wherein cam member tailpiece 106 is rotated about longitudinal axis 110 so that elongated portions 118 are aligned with surface 164 (see FIG. 4A) of sleeve 154 and cam member tailpiece 106 no longer overlaps a portion of rear side 22 of door or frame 10 (see FIG. 4A). In the unlocked position, electro-mechanical lock core 100 may be removed from passageway 12 of door or frame 10. When first collar 182 and second collar 184 are in the second home position, stops 230 of drive member 108 contact stop surfaces 236 of guides 232 in sleeve 154.

Referring to FIG. 4, water ingress into the interior of sleeve 154 is minimized by a first seal 250 positioned about drive member 108 and received in a recess in sleeve 154 and a second seal 252 positioned about operator actuation assembly 104 and received in a recess of sleeve 154. Additionally, adhesive may be placed in opening 156 which receives retainer 158. In embodiments, a silicone cover (not shown) may be placed over the exterior of operator actuation assembly 104.

A bracket 260 is provided having a first opening sized to be received over an outer surface of lock core body 150. Bracket 260 further includes a second opening 262 which may receive a cable that is used to tether electro-mechanical lock core 100 to an adjacent wall or frame.

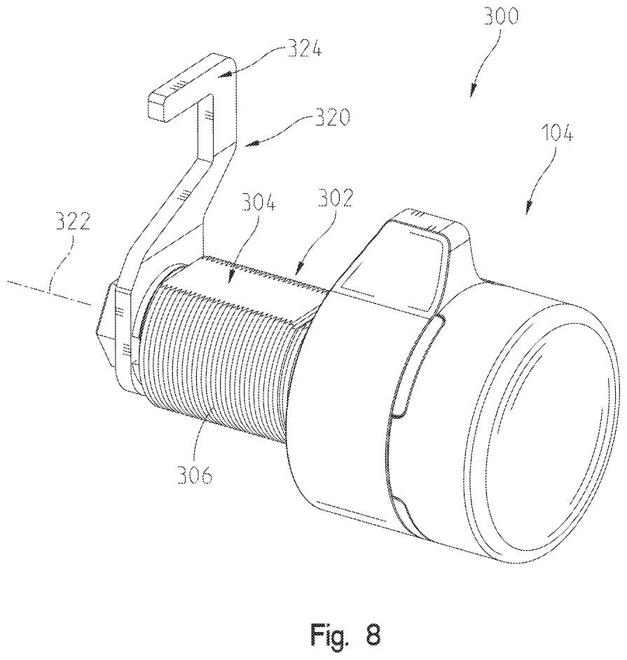

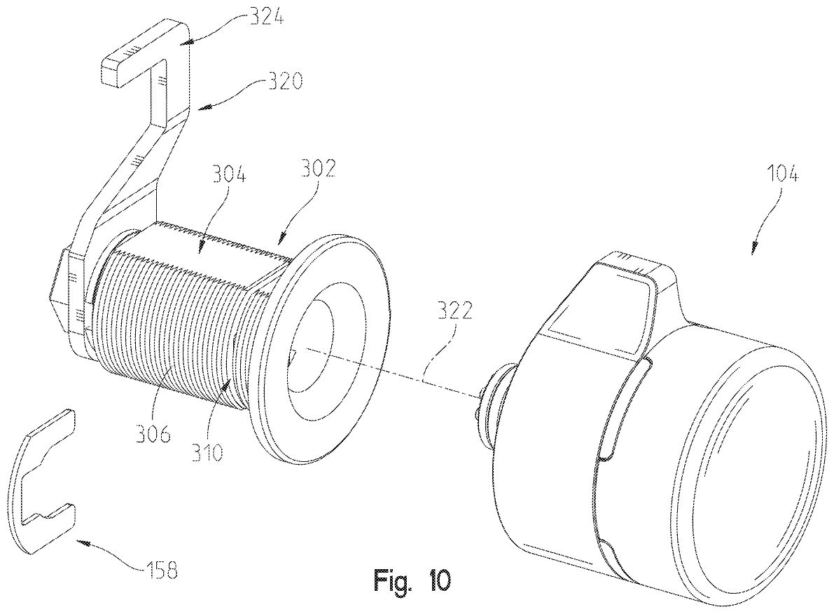

Referring to FIGS. 8-10, another exemplary electro-mechanical lock core 300. Electro-mechanical lock core 300 includes operator actuation assembly 104 and a lock core assembly 302 having a lock core body 304 with a threaded exterior 306. Lock core assembly 302 includes the same internals as core assembly 102 except that a separate sleeve, similar to sleeve 154, is not included, but rather lock core assembly 302 includes an opening 310 (see FIG. 10) which receives retainer 158 to couple operator actuation assembly 104 to lock core assembly 302 and lock core body has the same internal geometry as sleeve 154.

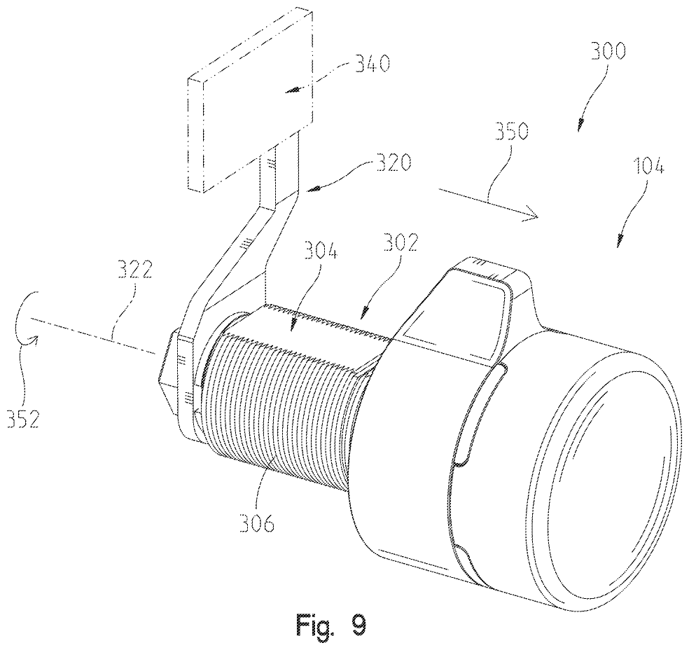

Electro-mechanical lock core 300 includes drive member 108 to which a cam member tailpiece 320 is coupled. Cam member tailpiece 320 rotates about axis 322 due to a rotation of drive member 108 about axis 322. Cam member tailpiece 320 is shown in a locked position in FIG. 9 wherein an end 324 (see FIG. 8) of cam member tailpiece 320 is positioned behind a catch 340 which is coupled to a frame (not shown) and prevents the movement of cam member tailpiece 320 and hence the door that electro-mechanical lock core 300 is coupled to from generally moving in direction 350.

When operator actuation assembly 104 is coupled to drive member 108, a rotation of operator actuation assembly 104 about axis 322 in direction 350 causes a rotation of drive member 108 and cam tailpiece 320 also in direction 352. This rotation moves 324 away from catch 340 such that electro-mechanical lock core 300 is moveable in direction 350 past catch 340. When end 324 does not overlap catch 340 along direction 350, electro-mechanical lock core 300 is in an unlocked position. End 324 of cam member tailpiece 320 is positioned outside of an exterior envelope of lock core body in both the locked position and the unlock position of cam member tailpiece 320.

Electro-mechanical lock core 300, in embodiments, is received in a bore (not shown) such as in a drawer and a nut (not shown) is threaded onto threaded surface 306 to retain electro-mechanical lock core 300 relative to the drawer.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of unlocking a lock, the method comprising the steps of:
blocking a movement of a lock member from a locked state to an unlocked state with a removeable lock core having a lock core body which is positioned in an aperture of the lock member when the lock member is in the locked state and is removed from the aperture of the lock member to transition the lock member to the unlocked state;
holding a cam member tailpiece of the removeable lock core in a first cam member tailpiece position which blocks removal of the lock core body from the aperture of the lock member;
providing an operator actuatable input supported by the removeable lock core, an electro-mechanical drive assembly having an engaged state wherein the operator actuatable input is operatively coupled with the cam member tailpiece so that a rotation of the operator actuatable input causes a movement of the cam member tailpiece from the first cam member tailpiece position to a second cam member tailpiece position, the second cam member tailpiece position permitting removal of the lock core body from the aperture of the lock member and a disengaged state wherein the operator actuatable input is operatively uncoupled from the cam member tailpiece;
communicating credential information between an electronic controller of the removeable lock core and a portable user device;
granting access to unlock the lock based on the credential information; and
transitioning the electro-mechanical drive assembly from the disengaged state to the engaged state.

2. The method of claim 1, wherein the step of transitioning the electro-mechanical drive assembly from the disengaged state to the engaged state is performed automatically without a manual manipulation of the operator actuatable input.

3. The method of any one of claims 1-2, further comprising the step of subsequent to a rotation of the operator actuatable input to move the cam member tailpiece from the first cam member tailpiece position to the second cam member tailpiece position, holding the cam member tailpiece of the removeable lock core in the second cam member tailpiece position.

4. A removeable lock core comprising:
a lock core body having a longitudinal axis and an exterior lock core body envelope surrounding the longitudinal axis;
a drive member supported by the lock core body and moveable relative to the lock core body;
a cam member tailpiece having an outer cam member tailpiece envelope, the cam member tailpiece extending from a first end of the lock core body and operatively coupled to the drive member, the cam member tailpiece being positionable in at least a first cam member tailpiece position relative to the lock core body wherein at least a portion of the outer cam member tailpiece envelope extends outside of the exterior lock core body envelope and a second cam member tailpiece position relative to the lock core body wherein the outer cam member tailpiece envelope is within the exterior lock core body envelope;
an electro-mechanical drive assembly including a clutch moveable between a first clutch position wherein the clutch is operatively disengaged from the drive member and a second clutch position wherein the clutch is operatively engaged to the drive member; and
an indexer which assists in holding the cam member tailpiece in a first cam member tailpiece position when the clutch is in the first clutch position.

5. The removeable lock core of claim 4, wherein the indexer further assists in holding the cam member tailpiece in the second cam member tailpiece position.

6. The removeable lock core of any one of claims 4-5, wherein the indexer is positioned within an interior of the lock core body.

7. The removeable lock core of any one of claims 4-6, wherein the indexer includes a first collar secured to the drive member to rotate with the drive member and a second collar which does not rotate with the drive member.

8. The removeable lock core of claim 7, wherein the drive member passes through each of the first collar and the second collar.

9. The removeable lock core of any one of claims 7-8, wherein each of the first collar and the second collar include a series of interactive protrusions and recesses, a first protrusion of the first collar being received in a first recess of the second collar when the cam member tailpiece is in the first cam member tailpiece position and the first protrusion of the first collar being received in a second recess of the second collar when the cam member tailpiece is in the second cam member tailpiece position.

10. The removeable lock core of any one of claims 7-9, wherein the second collar is translatable along the longitudinal axis relative to the first collar and the lock core further comprising a biasing member positioned to bias the second collar into contact with the first collar when the clutch is in the first position.

11. The removeable lock core of any one of claims 4-10, the electro-mechanical drive assembly further comprising:
an operator actuatable input moveably coupled to the lock core body;
an electric motor operatively coupled to the clutch to position the clutch in the first clutch position; and
a power source operatively coupled to the electric motor.

12. The removeable lock core of claim 11, wherein the electric motor is operatively coupled to the clutch to position the clutch in the second clutch position wherein the clutch is operatively engaged to the drive member.

13. The removeable lock core of any one of claims 11-12, wherein the operator actuatable input is freely rotatable about the longitudinal axis relative to the drive member when the clutch is in the first position and is rotatable about the longitudinal axis only through a defined angular range when the clutch is in the second position, a first end of the defined angular range corresponding to the cam member tailpiece being in the first cam member tailpiece position relative to the lock core body and a second end of the defined angular range corresponding to the cam member tailpiece being in the second cam member tailpiece position relative to the lock core body.

14. A cam lock for use with a catch, the cam lock comprising:
a lock body;
a drive member supported by the lock body and rotatable relative to the lock body about a longitudinal axis;
a cam member tailpiece coupled to the drive member and rotatable by the drive member, the cam member tailpiece having a first end coupled to the drive member and a second end opposite the first end, the first end being positionable by the drive member in a first cam member tailpiece position adapted to be in line with the catch and a second cam member tailpiece position adapted to be unaligned with the catch;
an electro-mechanical drive assembly including a clutch moveable between a first clutch position wherein the clutch is operatively disengaged from the drive member and a second clutch position wherein the clutch is operatively engaged to the drive member; and
an indexer which assists in holding the cam member tailpiece in the first cam member tailpiece position when the clutch is in the first clutch position.

15. The cam lock of claim 14, wherein the indexer further assists in holding the cam member tailpiece in the second cam member tailpiece position.

16. The cam lock of any one of claims 14-15, wherein the indexer is positioned within an interior of the lock body.

17. The cam lock of claim 16, wherein the indexer includes a first collar secured to the drive member to rotate with the drive member and a second collar which does not rotate with the drive member.

18. The cam lock of claim 17, wherein the drive member passes through each of the first collar and the second collar.

19. The cam lock of any one of claims 17-18, wherein each of the first collar and the second collar include a series of interactive protrusions and recesses, a first protrusion of the first collar being received in a first recess of the second collar when the cam member tailpiece is in the first cam member tailpiece position and the first protrusion of the first collar being received in a second recess of the second collar when the cam member tailpiece is in the second cam member tailpiece position.

20. The cam lock of any one of claims 17-19, wherein the second collar is translatable along the longitudinal axis relative to the first collar and further comprising a biasing member positioned to bias the second collar into contact with the first collar when the clutch is in the first position.

21. The cam lock of any one of claims 14-20, the electro-mechanical drive assembly further comprising:
an operator actuatable input moveably coupled to the lock body;
an electric motor operatively coupled to the clutch to position the clutch in the first clutch position; and
a power source operatively coupled to the electric motor.

22. The cam lock of claim 21, wherein the electric motor is operatively coupled to the clutch to position the clutch in the second clutch position wherein the clutch is operatively engaged to the drive member.

23. The cam lock of any one of claims 21-22, wherein the operator actuatable input is freely rotatable about the longitudinal axis relative to the drive member when the clutch is in the first position and is rotatable about the longitudinal axis only through a defined angular range when the clutch is in the second position, a first end of the defined angular range corresponding to the cam member tailpiece being in the first cam member tailpiece position relative to the lock body and a second end of the defined angular range corresponding to the cam member tailpiece being in the second cam member tailpiece position relative to the lock body.

24. The cam lock of any one of claims 14-23, wherein the second end of the cam member tailpiece is positioned outside of an exterior envelope of the lock body in both the first cam member tailpiece position and the second cam member tailpiece position.
